(19) United States
(12) Patent Application Publication
(10) Pub. No.: US 2016/0017924 A1
(43) Pub. Date: Jan. 21, 2016

(54) ROLLING-ELEMENT BEARING WITH LINE CONTACT INCLUDING A LUBRICANT CHANNEL

(71) Applicants: Riad Bauch, Wurzburg (DE); Eve Goujon, Wurzburg (DE); Norbert Huhn, Schweinfurt (DE)

(72) Inventors: Riad Bauch, Wurzburg (DE); Eve Goujon, Wurzburg (DE); Norbert Huhn, Schweinfurt (DE)

(73) Assignee: Aktiebolaget SKF, Goteborg (SE)

(21) Appl. No.: 14/803,748

(22) Filed: Jul. 20, 2015

(30) Foreign Application Priority Data
Jul. 18, 2014 (DE) 102014214001.3

(51) Int. Cl. F16C 33/66; F16C 19/26

(52) U.S. Cl. CPC F16C 33/6681; F16C 19/26

(57) ABSTRACT

A rolling-element bearing with line contact includes a bearing outer part having a running surface, a bearing inner part having a running surface, and at least one rolling element disposed between the bearing inner part and the bearing outer part. The at least one rolling element is configured to make line contact with the running surface of the bearing outer part and with the running surface of the bearing inner part, and either or both of the bearing inner and outer parts includes at least one lubricant channel that is at least partially open to the running surface.

### CROSS-REFERENCE

This application claims priority to German patent application no. 10 2014 214 001.3 filed on Jul. 18, 2014, the contents of which are fully incorporated herein by reference.

### TECHNOLOGICAL FIELD

The present disclosure is directed to a rolling-element bearing with line contact that includes a bearing outer part and a bearing inner part. Each of the inner and outer parts provides a running surface for at least one rolling element disposed therebetween, and the at least one rolling element contacts these running surfaces along a line when it rolls.

### BACKGROUND

All rolling-element bearings other than ball bearings are usually referred to as “rolling-element bearings with line contact.” Such bearings include, for example, cylindrical roller bearings, tapered roller bearings, radial needle roller bearings and toroidal roller bearings. However, one disadvantage of rolling-element bearings with line contact is that it can be difficult to distribute lubricant over their entire length, and often as a result too little lubricant is available in the inner region of the contact line, that is, near the axial midpoint of the rolling element.

A radial needle roller bearing is known from EP 1 775 484 (a family member of U.S. Pat. No. 7,628,133) that has an inner running surface that tapers in a partial region. The needle rollers are thus locally and temporarily located over the bearing seat so that lubricant can be guided directly onto the needle rollers. However, a disadvantage of this prior art approach is that the needle rollers are not well supported in the strongly tapered region. In addition, at least parts of the needle rollers are constantly covered by the bearing seat, and the covered regions may not be adequately supplied with lubricant. In addition, the central region of the rolling element is the most heavily loaded.

### SUMMARY

One aspect of the present disclosure is therefore to provide improved lubrication for a rolling-element bearing with line contact.

According to an aspect of the disclosure a rolling-element bearing with line contact includes a bearing outer part and a bearing inner part, each of which forms a running surface for at least one rolling element disposed therebetween. During a rolling movement the rolling elements make contact with the running surfaces along a line. To improve rolling-element lubrication, a lubricant channel is formed in the outer part and/or in the inner part and is at least partially open to the running surface. This lubricant channel allows the lubricant to reach the inner region of the rolling-element bearing and thus provides direct access for the lubricant to the rolling elements. It is particularly preferred if the lubricant channel is formed in a part of the rolling-element bearing assembly that is subjected to as little load as possible. Thus, for example, the lubricant channel in known rolling-element bearings can be disposed in the outer part since, for example, in the case of a rotating load on the inner part and stationary load on the outer part the outer part is loaded less than the inner part. Alternatively, as in the case of an unbalanced shaft, for example, the inner part can also include the lubricant channel. Particularly in the case of an unbalanced shaft, a load zone and not-loaded zone arise over the circumference of the inner part of the rolling-element bearing. In this case it can be advantageous to provide an open lubricant channel in the not-loaded zone.

According to a further advantageous exemplary embodiment, the lubricant channel has a length, at least in the region where it is open toward the running surface, whose longitudinal direction is angled with respect to the line contact of the rolling element. That is, the channel extends in a direction angled relative to (not parallel or perpendicular to) the line contact of the rolling element. This angled configuration of the lubrication channel helps ensure that the rolling elements are always supported along at least one part of their contact line. Other designs are of course possible in which the rolling elements are supported by the running surfaces at least along a part of the contact line. Thus, for example, a lubricant channel can be provided that extends parallel to the axis of rotation but which is not open to the running surface over its entire length. Such a channel would only include individual openings along its length, via which lubricant can reach the rolling elements. The lubricant channel could then be described as a tunnel or bore having window openings.

Overall, however, the inventive lubricant channel makes it possible to guide lubricant to regions of the rolling elements that would ordinarily be inaccessible to lubricant because of the line contact of the rolling elements.

As a further preferred exemplary embodiment shows, the inner part and/or the outer part can also include a flange for axially supporting the rolling elements. When a flange is present, at least one bore is provided to fluidly connect an outer region of the bearing assembly (on the side of the flange opposite the rolling elements) to the lubricant channel. The presence of a retaining flange and/or a guide flange makes it particularly difficult to provide lubricant to rolling-elements with line contact. However, using the disclosed configuration of a bearing inner part and/or bearing outer part having a lubricant channel and a bore, lubricant can be directed onto the rolling elements in a targeted manner such that an improved lubrication can be provided even in the presence of the retaining flange.

In some exemplary embodiments, the running surfaces of the bearing outer ring and/or the running surfaces of the bearing inner ring have a smaller width, at least in some regions, than the axial lengths of the rolling elements. In these exemplary embodiments it may still be useful to provide a lubricant channel, since only limited lubrication is possible in the running surface regions that are as wide as the rolling elements. Even in the region of reduced width, however, lubricant channels can provide improved lubrication.

Since such rolling-element bearings with line contact are commonly used in radial bearing assemblies of unbalanced shafts, a use of the inventive rolling-element bearing in the radial bearing assembly of an unbalanced shaft is especially preferred.

Further advantages and advantageous embodiments are depicted in the dependent claims, the description, and the drawings.

The invention is explained in greater detail in the following disclosure with the help of exemplary embodiments depicted in the drawings. The exemplary embodiments are purely exemplary in nature and are not intended to define or limit the scope of the application. The scope of the application is defined solely by the appended claims.

### BRIEF DESCRIPTION OF THE DRAWINGS

FIG. 1a is a schematic side elevational view of a rolling-element bearing inner part having a lubricant channel according to an embodiment of the disclosure.

FIG. 1b is a detail view of an axial end of the bearing inner part of FIG. 1a showing an end of the lubricant channel.

FIG. 2a is a schematic side elevational view of a rolling-element bearing inner part having a lubricant channel according to another embodiment of the disclosure.

FIG. 2b is a sectional view through line B-B in FIG. 2a

FIG. 2c is a sectional view through line C-C in FIG. 2a.

FIG. 3a is a schematic perspective view of a rolling-element bearing inner part having a lubricant channel according to another embodiment of the disclosure.

FIG. 3b is a schematic side elevational view of the rolling-element bearing inner part of FIG. 3a.

FIG. 3c is a side elevational view of a portion of an axial end of the rolling-element bearing inner part of FIG. 3a.

FIG. 4 is a side elevational view, partly in section, of the rolling-element bearing inner part of FIG. 1a mounted inside a rolling-element bearing outer part.

FIG. 5 is a sectional side elevational view of the rolling-element bearing outer part of FIG. 4 with the rolling-element bearing inner part and rolling-elements removed for clarity.

### DETAILED DESCRIPTION

In the following discussion, identical or functionally identical elements are indicated by the same reference numerals.

The following discussion is directed primarily to an inner part of a rolling-element bearing with line contact. The discussion applies equally to rolling-element bearings that include lubricant channels in their outer parts instead of or in addition to in their inner parts.

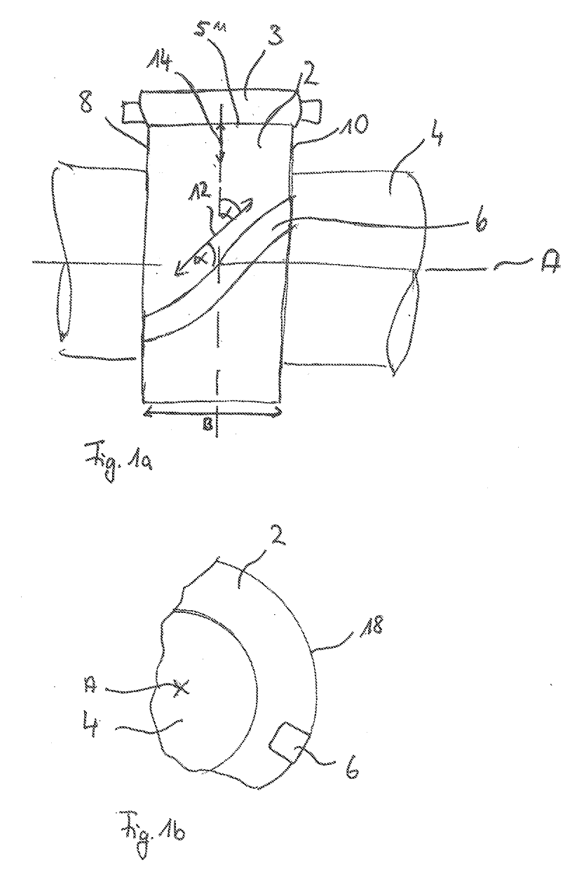

FIGS. 1a and 1b schematically show various views of an inner part 2 of a rolling-element bearing 1 with line contact that is disposed on a shaft 4. A “rolling-element bearing with line contact” is usually understood to mean a rolling-element bearing having rolling elements 3, as shown in FIG. 1, that contact the running surfaces of the bearing rings, such as inner part 2, along a line 5. FIG. 1b is a view of the inner part 2 taken in an axial direction and showing an axial end of the inner part 2.

As can be further be seen in FIGS. 1a and 1b, a lubricant channel 6 is formed on the inner part 2 (or on the outer part 7 as shown in FIGS. 4 and 5) which lubricant channel 6 extends over the entire width B of the inner part 2 and is open at the axial edges 8, 10 of the inner part 2. The lubricant channel 6 can have a slightly curved shape, although it is also possible for the lubricant channel to be linear. The curved shape can easily be produced during a manufacturing process if the lubricant channel is formed as a milled groove. This may be accomplished, for example, by axially moving a milling tool while rotating the inner part synchronously with the tool. Of course other shapes are also possible such as, for example, a wave shape, in particular, a wave shaped channel having an entrance end at axial edge 8 and an exit end at axial edge 10 that are at the same circumferential location on the bearing inner part 2.

It can further be seen in the exemplary embodiment shown in FIG. 1a that a longitudinal alignment 12 of the lubricant channel 6 is angled relative to (is not perpendicular or parallel to) both an axis of rotation A about which the inner part 2 or the outer part 7 of the rolling-element bearing rotates and with respect to a rolling direction 14 of the rolling elements 3. This angled arrangement ensures that the rolling elements 3 are always at least partially supported along their line contact 5, which is substantially parallel to the axis of rotation A, by one of the inner part 2 or the outer part 7. The angled arrangement furthermore generates a preferred pumping direction of the lubricant in the fluid channel 6 with a given direction of rotation of the bearing part. As can particularly be seen in the section view of FIG. 1b, the lubricant channel 6 is open to at the running surface 18 of the inner part 2 and can have any desired cross-sectional shape. FIG. 1b schematically shows an essentially rectangular cross-section, but it is also possible to form triangular or curved (e.g., semicircular) cross sections. The cross-section is determined by the tool used to mill the lubricant channel 6 into the inner part 2.

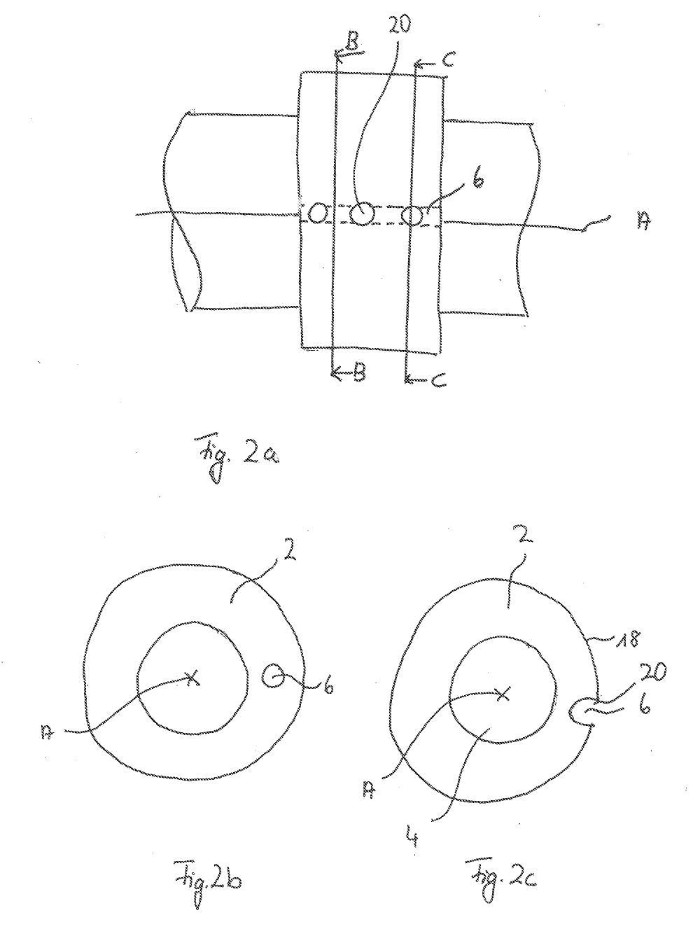

FIGS. 2a-2c show a further advantageous exemplary embodiment of the subject rolling-element bearing. Unlike the embodiment of FIGS. 1a and 1b, the lubricant channel 6 of this embodiment is not open over the entire width B of the inner part 2, but rather is formed as a tunnel or internal bore 6 that has window openings 20. This tunnel-shaped design can particularly be seen in the sectional views of FIG. 2b, a sectional view through an enclosed part of the bore and FIG. 2c, a sectional view through one of the window openings 20. In other words, FIG. 2b shows that the lubricant channel 6 is configured in a first partial region as a bore, while FIG. 2c shows that in a further partial region, the lubricant channel 6 is open to the running surface 18. These window openings 20 allow the lubricant channel 6 to extend essentially parallel to the axis of rotation A, thus making it possible to supply the rolling elements 3 with lubricant even at very difficult-to-access locations while still providing adequate support for the rolling elements 3 around the entire circumference of the inner bearing part. This embodiment could also be combined with the first embodiment so that a lubricant channel 6 has one or more first open portions that extend at an angle to the line contact of the rolling-element bearings and one or more closed portions having windows 20 that extend parallel to the line contact direction.

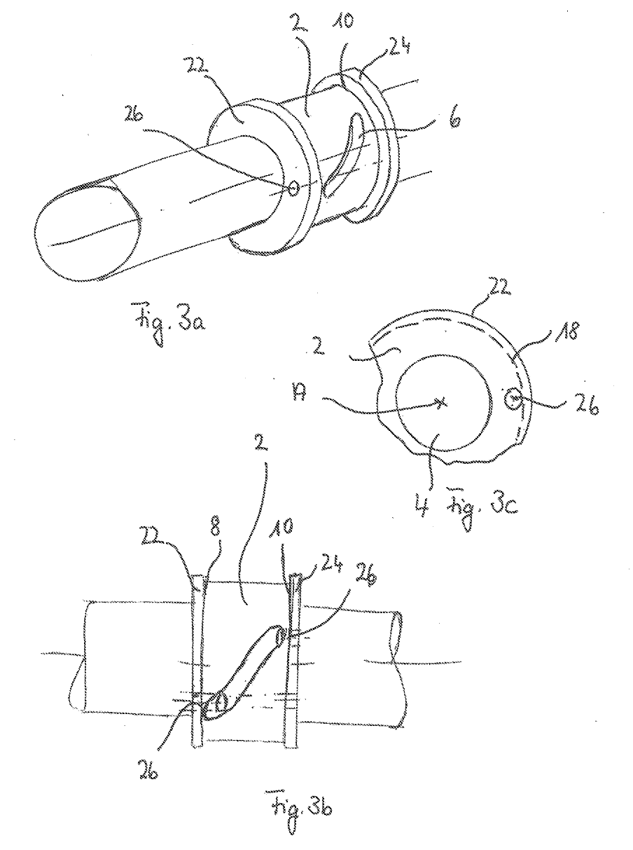

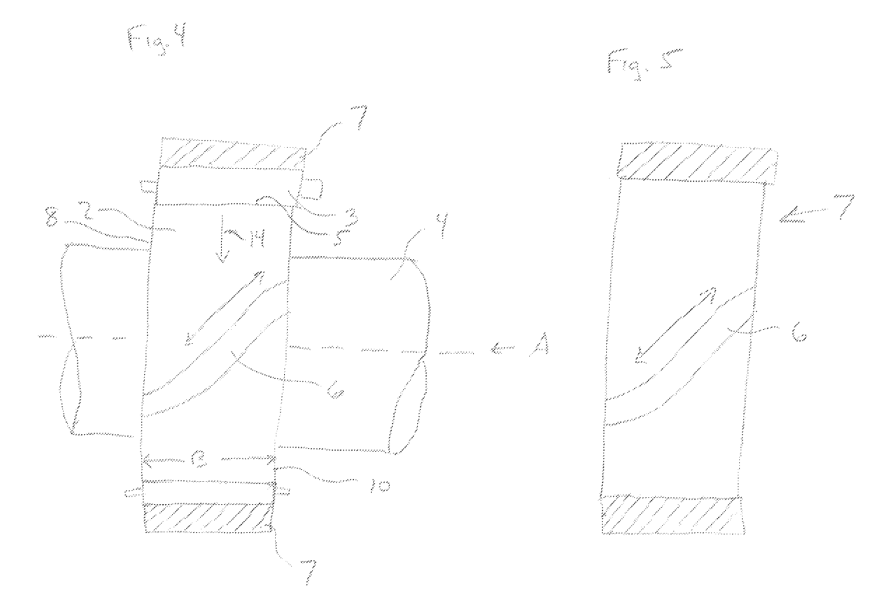

FIGS. 3a-3c show another preferred exemplary embodiment of an inner part 2 having a lubricant channel 6. The inner part 2 of this embodiment includes first and second flanges 22, 24 on its edges 8, 10, which flanges 22, 24 serve to axially support the rolling elements 3. The presence of flanges 22, 24 makes it particularly difficult to guide lubricant to the rolling elements 3.

As can furthermore be seen in FIGS. 3a to 3c, a bore 26 is provided on each flanges 22, 24, which bore is fluidly connected to the lubricant channel 6, as can particularly be seen in FIG. 3b. Lubricant can thereby be conducted from a region outside the flanges 22, 24 into the lubricant channel 6 and thus onto the rolling elements 3. As can be seen in particular in FIG. 3c, the bore is disposed in the flanges 22, 24 such that it is formed as close as possible to the running surface 18 of the inner part 2 so that it can transition directly into the open channel 6. Alternately, the bore 26 can be disposed sufficiently far beneath the running surface 18 so as not to excessively weaken the running surface and still be made to intersect an axial end wall of the lubricant channel 6.

Overall, using the inner part 2 having a lubricant channel according to the disclosed embodiments, it can be ensured that even in a central region of the line contact 5, lubricant can reach rolling elements 3, so that an improved lubricating of the rolling elements 3 can be provided. The shape of the lubricant channel 6 can be chosen at will.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved rolling-element bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Rolling-element bearing
2 Inner part of a rolling-element bearing
3 Rolling element
4 Shaft
5 Line contact
6 Lubricant channel
7 Outer part of a rolling-element bearing
8, 10 Axial ends of the inner part
12 Longitudinal direction of the lubricant channel
14 Rolling direction of the rolling elements
16 Line contact of the rolling elements
18 Running surface
20 Window opening
22,24 Flange
26 Bore

1. A rolling-element bearing with line contact comprising:
a bearing outer part having a running surface;
a bearing inner part having a running surface; and
at least one rolling element disposed between the bearing inner part and the bearing outer part, the at least one rolling element making line contact with the running surface of the bearing outer part and with the running surface of the bearing inner part,
wherein the bearing inner part or the bearing outer part or both the bearing inner part and the bearing outer part includes at least one lubricant channel, and the at least one lubricant channel at least partially open to the running surface.

2. The rolling-element bearing according to claim 1, wherein the at least one rolling element is supported by the running surfaces of the bearing inner part and the bearing outer part at least along one part of the line contact around the entire circumference of the rolling-element bearing.

3. The rolling-element bearing according to claim 1, wherein the at least one lubricant channel includes a portion open to the running surface and wherein the portion open to the running surface is angled relative to the line contact of the rolling elements.

4. The rolling-element bearing according to claim 1, wherein the at least one lubricant channel includes a portion open to the running surface and wherein the portion open to the running surface comprises a plurality of discrete openings along a length of the at least one lubricant channel.

5. The rolling-element bearing according to claim 1, wherein the inner part or the outer part includes at least one flange configured to axially support the rolling elements, and the at least one flange including a bore fluidly connected to the at least one lubricant channel.

6. The rolling-element bearing according to claim 1, wherein the at least one rolling element has an axial rolling-element width, the running surface of the bearing outer ring has an axial outer running-surface width, and the running surface of the bearing inner ring has an axial inner running-surface width, and wherein the outer running-surface width and/or the inner running-surface width is less, at least in a first circumferential partial region, than the width of the rolling element.

7. The rolling-element bearing according to claim 6, wherein the at least one lubricant channel is disposed at least in the first partial region.

8. The rolling-element bearing according to claim 1, wherein the running surface of the inner part or the running surface of the outer part are formed as a bearing seat of a radial bearing assembly of an unbalanced shaft.

9. The rolling-element bearing according to claim 1, wherein the at least one lubricant channel has a first end at a first axial edge of the bearing inner part or at a first axial edge of the bearing outer part and a second end at a second axial edge of the bearing inner part or at a second axial edge of the bearing outer part, wherein the first end of the lubricant channel is axially and circumferentially offset relative to the second end.

10. The rolling-element bearing according to claim 1, wherein, if the lubricant channel is formed in the bearing inner part, the lubricant channel extends from a first axial end of the bearing inner part to a second axial end of the bearing inner part and is open from the first axial end of the bearing inner part to the second axial end of the bearing inner part and if the lubricant channel is formed in the bearing outer part, the lubricant channel extends from a first axial end of the bearing outer part to a second axial end of the bearing outer part and is open from the first axial end of the bearing outer part to the second axial end of the bearing outer part.

11. The rolling element bearing according to claim 1, wherein the lubricant channel is formed in the bearing inner part and has first and second axial end sections closed to the running surface of the bearing inner part and at least one central section between the first and second axial end sections open to the running surface of the bearing inner part.
